(19) United States
(12) Patent Application Publication
(10) Pub. No.: US 2011/0145063 A1
(43) Pub. Date: Jun. 16, 2011

(54) TARGETING APPLICATIONS WITH ADVERTISEMENTS

(75) Inventors: Rashid Qureshi, Redmond, WA (US); Ashwini Varma, Renton, WA (US); Vinay Gupta, Sammamish, WA (US); Scott Michael Bragg, Snoqualmie, WA (US); Francis X. Dougherty, Redmond, WA (US)

(73) Assignee: MICROSOFT CORPORATION, Redmond, WA (US)

(21) Appl. No.: 12/638,605

(22) Filed: Dec. 15, 2009

(51) Int. Cl. G06Q 30/00; G01S 3/02

(52) U.S. Cl. 705/14.52; 342/457

(57) ABSTRACT

Collecting application execution data by a push service and targeting application programs with advertisements based on the collected data. Statistics such as activity, popularity, and frequency of execution for each of the application programs are generated based on the collected data. The statistics are matched to advertising campaigns to select application programs relevant to the advertising campaigns. Advertisers are charged for delivering the advertisements based on the selected application programs. For example, advertisements delivered to frequently executed application programs are more expensive than advertisements delivered to application programs that are rarely executed.

### BACKGROUND

Some existing advertising systems provide advertisements for display in web pages on user devices, such as in a banner or frame along the edges of the web pages. The advertisements are cached locally on the user devices. When the web pages are displayed, one or more of the advertisements are selected from the cache and included in the web pages. For example, the advertisements are selected in a round-robin manner. The advertising systems charge the advertisers for displaying the selected advertisements based on the frequency of display of the advertisements.

For existing advertising systems on mobile devices, several application programs may execute on the mobile devices to display advertisements from the advertising systems. The application programs asynchronously poll the advertising systems for the advertisements, draining battery life and degrading the user experience on the mobile devices.

### SUMMARY

Embodiments of the disclosure enable the targeting of application programs with advertisements. A push service receives application execution data from at least one computing device. The application execution data describes an execution environment of the computing device. The received application execution data is analyzed to generate application statistics corresponding to the execution environment. At least one advertisement campaign defined by an advertiser is accessed. At least one application program on the computing device is identified to receive an advertisement based at least on the generated application statistics and the accessed advertisement campaign. The push service provides the advertisement to the identified application program.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for targeting application programs executing on computing devices with advertisements.

FIG. 2 is an exemplary block diagram illustrating computer-executable components for targeting application programs with advertisements.

FIG. 3 is an exemplary block diagram illustrating a push service collecting business intelligence data from a mobile computing device and sending advertisements to the mobile computing device.

FIG. 4 is an exemplary flow chart illustrating operation of the delivery of advertisements to selected application programs.

Corresponding reference characters indicate corresponding parts throughout the drawings.

### DETAILED DESCRIPTION

Referring to the figures, embodiments of the disclosure enable, at least, advertisers 108 to target application programs 110 with advertisements 322. In some embodiments, a push service 302 collects application execution data 314 from a plurality of computing devices 102, analyzes the collected data, selects the application programs 110 to be targets of advertisement campaigns from the advertisers 108, and sends advertisements 322 to the selected application programs 110. The application execution data 314 describes application program activity and associates temporal (e.g., time of day, duration, etc.) and geographic attributes (e.g., location). In further embodiments, the advertisers 108 are charged based on the selected application programs 110 for delivering the advertisements 322.

Aspects of the disclosure enable advertisers 108 to effectively target application programs 110 based on popularity, activity, location, user identity, user demographic, time of day, day of week, month, and other factors. Further, by using the push service 302 (e.g., each of the computing devices 102 has a single push channel with the push service 302), battery life on the computing devices 102 is improved as the application programs 110 receive advertisements 322 without polling or actively requesting the advertisements 322. Also, additional advertisement-enabled application programs 110 may be installed on the computing devices 102 without degrading the user experience (e.g., the burden on each application program 110 to create and maintain a persistent connection is reduced) and without consuming additional bandwidth.

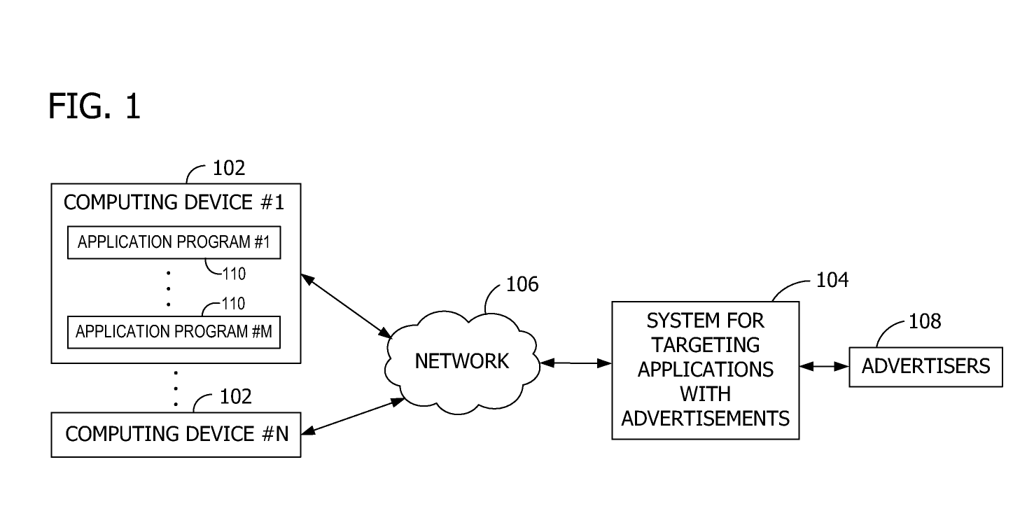

Referring again to FIG. 1, an exemplary block diagram illustrates a system 104 for targeting application programs 110 executing on the computing devices 102 with advertisements 322. The computing devices 102 include any devices capable of computation and/or data display, such as computing device #1 through computing device #N. In some embodiments, the computing devices 102 include portable computing devices such as mobile telephones, laptops, netbooks, gaming devices, and/or portable media players. Further, each of the computing devices 102 may represent a group of processing units or other computing devices, such as in a cloud computing environment.

The computing devices 102 execute one or more of the application programs 110, such as application #1 through application #M. The application programs 110 include instructions for performing operations on the computing devices 102. The instructions are in any format including executable objects and/or text, and may be either human-readable, machine-readable, or both. In some embodiments, the application programs 110 include web browsers.

The system 104 communicates with the computing devices 102 via at least one network 106. Exemplary networks 106 include wired and/or wireless networks, and may represent local area networks or global networks such as the Internet. In embodiments in which the network 106 includes wireless networks, the computing devices 102 may be enabled with technology such as BLUETOOTH brand wireless communication services (secured or unsecured), radio frequency identification (RFID), wireless fidelity (Wi-Fi) such as peer-to-peer Wi-Fi, ZIGBEE brand wireless communication services, near field communication (NFC), and other technologies that enable short-range or long-range wireless communication.

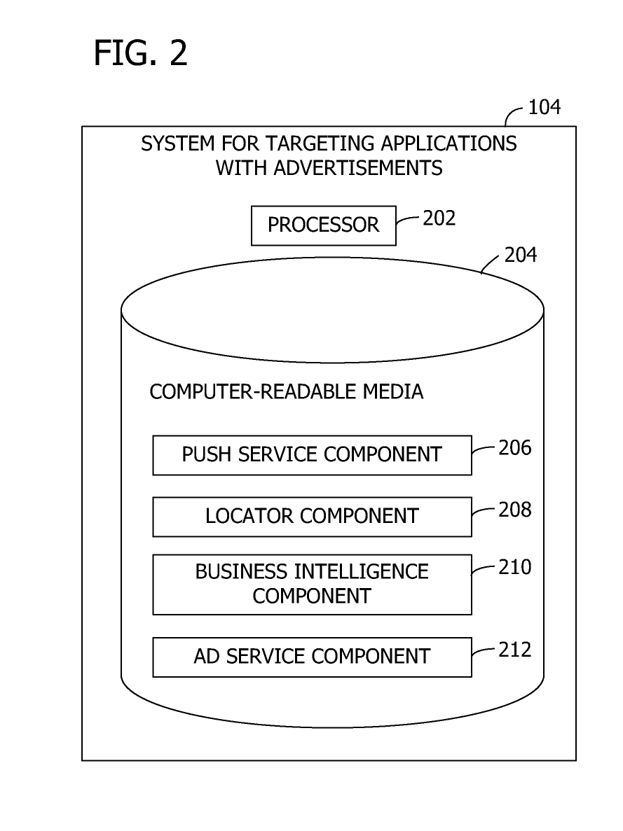

The system 104 communicates with one or more of the advertisers 108. The advertisers 108 interact with the system 104 electronically (e.g., via a computer) or manually (e.g., human agents of the advertisers 108 interface with the system 104, or a representative thereof). The system 104 enables the targeted delivery of advertisements 322 from the advertiser 108 to the application programs 110, as next described with reference to FIG. 2.

Referring next to FIG. 2, an exemplary block diagram illustrates computer-executable components for targeting the application programs 110 with advertisements 322. The system 104 has at least one processor 202 and one or more computer-readable media 204.

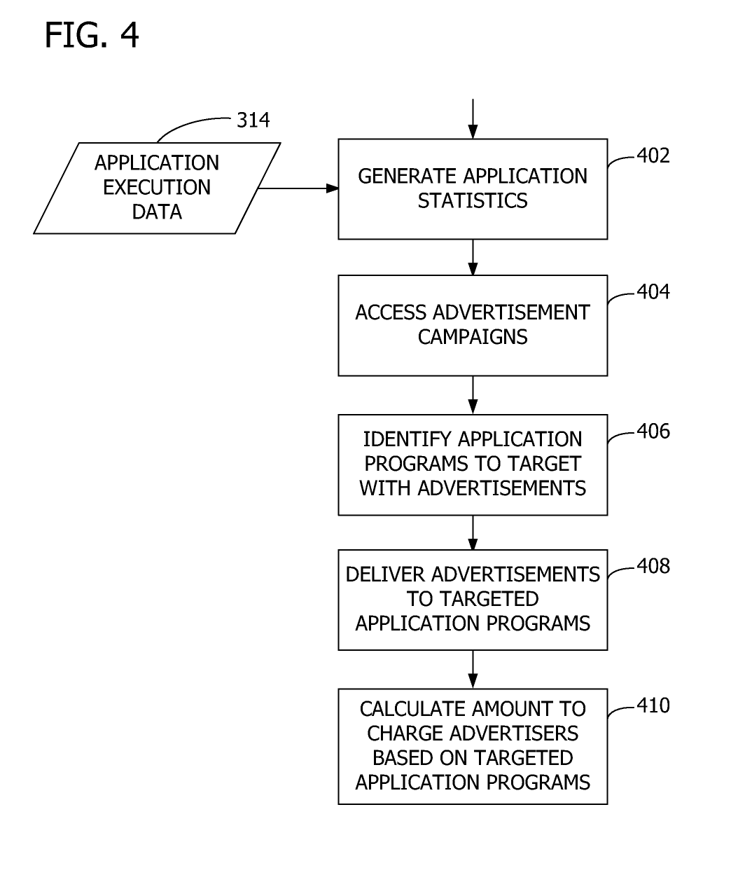

The processor 202 includes any quantity of processing units, and is programmed to execute computer-executable instructions for implementing aspects of the disclosure. The instructions may be performed by the processor 202 or by multiple processors executing within the system 104, or performed by a processor external to the system 104 (e.g., by a cloud service). In some embodiments, the processor 202 is programmed to execute instructions such as those illustrated in the figures (e.g., FIG. 4).

The computer-readable media 204 include any quantity of media accessible to the system 104. The computer-readable media 204 may be internal to the system 104 (as shown in FIG. 2), external to the system 104 (not shown), or both (not shown).

The computer-readable media 204 include one or more computer-executable components for implementing aspects of the disclosure. Exemplary components include a push service component 206, a locator component 208, a business intelligence component 210, and an ad service component 212. The push service component 206, when executed by the processor 202, causes the processor 202 to receive application execution data 314 from at least one of the computing devices 102. The application execution data 314 describes an execution environment of the computing devices 102. Exemplary application execution data 314 includes application name, application type, service name, application version, and application vendor. Additional exemplary application execution data 314 includes a geographic location of the computing devices 102, identities of the computing devices 102, identities of the users executing the application programs 110, device data (e.g., operating system version, model, serial number, etc.), and times of execution of the application programs 110.

The locator component 208, when executed by the processor 202, causes the processor 202 to determine a location of at least one of the computing devices 102. In some embodiments, the location component 208 determines the location of a plurality of the computing devices 102 within a particular geographic area. The locator component 208 determines the location of the computing device 102 based on, for example, crowd-sourced data and/or data from a global positioning system.

The business intelligence component 210, when executed by the processor 202 causes the processor 202 to generate, based on the application execution data 314 received by the push service component 206, application statistics 316 corresponding to the execution environment. For example, the business intelligence component 210 determines a frequency of execution of the application program 110, and/or determines a quantity of messages received by or sent to the application program 110. Exemplary application statistics 316 may include an activity index and/or popularity index for each of the application programs 110. The activity index represents a measure or indicator of the activity of the executing application programs 110 (e.g., message activity such as quantity of received notifications, processing activity, storage activity, etc.). The popularity index represents a measure or indicator of the frequency or quantity of execution of the application programs 110. Each of the application statistics 316 may also be associated with a time of day, day of week, month of year, location of execution, or other criteria. Other application statistics 316 include, for example, a home region of the computing device 102 and mapping between a user identity and a device identity.

In embodiments in which the push service component 206 receives the application execution data 314 from a plurality of computing devices 102, the business intelligence component 210 groups the application programs 110 based on one or more of the following: an identity of the user, the locations of the computing devices 102, activity of the application programs 110, and the popularity of the application programs 110. For example, the application programs 110 associated with a particular user are grouped together, the application programs 110 executing on computing devices 102 physically located near each other are grouped together, or the top five application programs 110 frequently executed are grouped together.

In some embodiments, the business intelligence component 210 generates the application statistics 316 as the push service component 206 receives the application execution data 314. In other embodiments, the business intelligence component 210 generates the application statistics 316 at a predefined time interval (e.g., on a batch basis).

The ad service component 212, when executed by the processor 202 causes the processor 202 to identify at least one of the application programs 110 available on the computing devices 102 to receive at least one of the advertisements 322 based on the application statistics 316 generated by the business intelligence component 210, an advertisement campaign defined by the advertisers 108, and the location of the computing device 102 determined by the locator component 208. The advertisement campaigns represent specifications by the advertisers 108 for publishing advertisements 322 of the advertisers 108 on certain device types, or based on certain keywords. For example, the advertisement campaign may specify an application type and list of advertisements 322 for display with the application type. In another example, the computing device 102 maintains a log of recent searches performed by the user and transfers the log to the push service 302 in a heartbeat packet. In this manner, if a user searches for “car” and there is an advertisement campaign related to cars, the advertisement service 320 can target those devices with car advertisements. The search keywords can be grouped with the user identity and/or demographic information by the business intelligence component 210.

Exemplary advertisement campaigns are defined and/or provided by the advertisers 108 and includes one or more profiles of desired target application programs 110. In other embodiments, the advertisement campaigns are generated by the system 104. The system 104 identifies one or more of the application programs 110 that are relevant targets for the advertising campaign based on the specifications of the advertising campaign, and further selects one or more of the advertisements 322 to deliver to the identified application programs 110.

The push service component 206 delivers the advertisement 322 to the application program 110 identified by the ad service component 212. The push service component 206 receives an acknowledgment (e.g., impression information) from the identified application program 110, and updates the ad service component 212 (or advertisers 108 or advertisement system) with the impression information. In some embodiments, the ad service component 212 calculates, based on the identified application and possibly other factors such as the impression information, an amount to charge the advertiser 108 for delivering the advertisement 322. Alternatively or in addition, the ad service component 212 performs the calculation and billing offline. The ad service component 212 may also offer a tiered pricing structure. For example, the advertisers are charged a first amount for the first 100 advertisements 322 served, and a second amount for the next 100 advertisements 322.

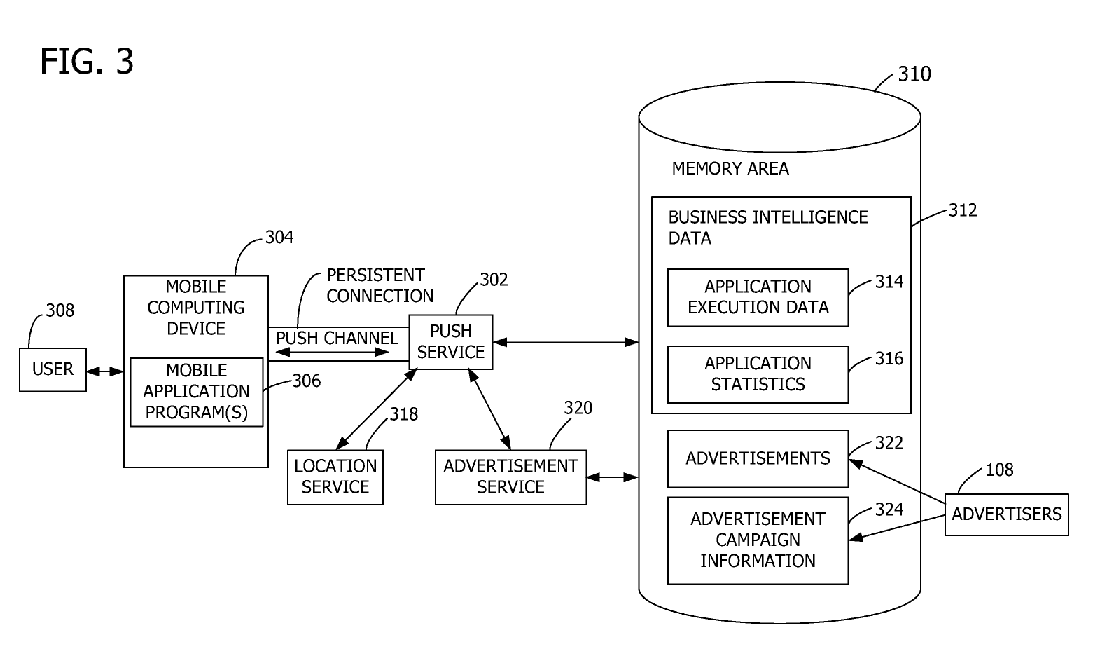

In some embodiments, the functionality of system 104 is divided among various elements such as the example of FIG. 3 as next described.

Referring next to FIG. 3, an exemplary block diagram illustrates the push service 302 collecting business intelligence data 312 from at least one mobile computing device 304 and sending advertisements 322 to the mobile computing device 304. While the illustration and description of FIG. 3 refers to communication between the push service 302 and the mobile computing device 304, the push service 302 may also communicate with other computing devices. Further, in some embodiments, the system 104 includes one or more of the following: the push service 302, location service 318, advertisement service 320, and memory area 310.

The push service 302 uses a push channel over a persistent connection between the push service 302 and at least one mobile application program 306 executing on one or more mobile computing devices 304. Exemplary push services 302 includes message push technology such as Internet Protocol (IP), hypertext transfer protocol (HTTP), short message system (SMS), and messages sent using the 802.11 family of standards. Further, the push service 302 communicates with the mobile computing device 304 via non-proximity-based means in addition or alternative to proximity-based means.

In some embodiments, there is a one-to-one mapping between the push channel and each mobile application program 306. A service such as a web service uses the push channel to send notifications to a counterpart mobile application program 306 corresponding to the service. In such embodiments, a push service client stack (not shown) on the mobile computing device 304 establishes the persistent connection with the push service 302. For example, to create the persistent connection, the push service client stack sends one or more of the following data items to the push service 302: country code, operator code, locale, device identifier, device model, manufacturer, and operating system version.

Each of the mobile application programs 306 executing on the mobile computing device 304 use the push service client stack to create a push channel over the persistent connection. For example, to create the push channel, the push service client stack sends an application name, application type, service name, application version, application vendor, and/or other application execution data 314 to the push service 302.

Upon creation of the push channel, the mobile application program 306 receives a token associated with the push channel. The mobile application program 306 passes the token to the service executing remote from the mobile computing device 304. For example, the token may be a uniform resource identifier (URI) with push service 302 endpoint information and push channel information. The push channel information may be in clear text or encrypted. The service extracts the push channel information from the URI to send notifications to the mobile application program 306. For example, the push service 302 receives the notification from the service and forwards the notification over the push channel to the mobile computing device 304. The push service client stack receives the notification and forwards the received notification to the intended mobile application program 306. The push service client stack sends an acknowledgment to the push service 302 upon receipt of the notification.

The push service 302 communicates with the memory area 310 The memory area 310 stores, among other data, business intelligence data 312 which includes, for example, the application execution data 314 received from the computing devices 102 (e.g., including the mobile computing device 304) and the application statistics 316. The push service 302 generates the application statistics 316 corresponding to the execution environment. In some embodiments, the application statistics 316 are based on the application execution data 314 stored in the memory area 310. In some embodiments, another operational element such as the advertisement service 320 accesses the application execution data 314 in the memory area 310 to generate the application statistics 316.

The memory area 310 further stores one or more advertisements 322 and advertisement campaign information 324. The advertisements 322 and advertisement campaign information 324 are defined and/or provided by one or more of the advertisers 108. For example, the advertisers 108 provide copies of the advertisements 322 (e.g., audio, video, still images, text, etc.). The advertisement service 320 accesses the advertisement campaign information 324. In some embodiments, the advertising system defines a sample or template advertisement campaign based on the application statistics 316. Example advertisement campaigns and templates include the following: display advertisements 322 with highly popular mobile application programs 306, display advertisements 322 with highly active mobile application programs 306, display advertisements 322 with particular types of mobile application programs 306, display advertisements 322 with mobile application programs 306 executed by users 308 of a desired demographic, display advertisements 322 with mobile application programs 306 executing in desired locations or geographic regions, or any combination of the above. The advertisers 108 may then select one of the template advertisement campaigns, modify the selected advertisement campaign, and/or define custom advertisement campaigns.

The advertisement service 320 identifies at least one of the mobile application programs 306 as a target for at least one of the advertisements 322. The targeted mobile application program 306 is identified based on the application statistics 316 and/or the advertisement campaign information 324. The push service 302 delivers the advertisement 322 to the identified mobile application program 306. For example, the advertisement 322 is sent to the mobile computing device 304 with instructions to display the advertisement 322 within the context of the mobile application program 306 during execution. In an example in which the advertisement 322 is available in a cache local to the mobile computing device 304, the mobile computing device 304 displays the advertisement 322 to the identified mobile application program 306 from the cache. If the advertisement 322 is unavailable locally, the advertisement 322 is pulled from the advertising system.

The advertisement system, or other element, calculates an amount to charge the advertiser 108 associated with the advertisement 322 that was provided to the mobile application program 306. The charge amount is based on, for example, one or more of the following: popularity of the mobile application program 306, type of the mobile application program 306, frequency of execution of the mobile application program 306, availability of targeting data (e.g., application execution data 314), and location of mobile application program 306 execution.

In some embodiments, the push service 302 receives location information from the mobile computing device 304. The location information may be sent as a “heartbeat” message from the push service client stack to maintain the persistent connection. The location information describes a location of the mobile computing device 304 and includes, for example, latitude/longitude coordinates from a global positioning system, street address information, landmark information, meeting location information (e.g., from a calendar of the user 308), and/or identification and signal strength of nearby network beacons (e.g., Wi-Fi beacon map or cell tower map). Based on the received location information, the location service 318 determines and/or confirms a location of the mobile computing device 304. In such embodiments, the advertisements 322 are selected in part based on the determined or confirmed location of the mobile computing device 304. For example, if the mobile computing device 304 is determined to be in a sports stadium, a beverage advertisement may be selected.

In general, the memory area 310 is associated with the push service 302. However, the memory area 310 includes any memory area accessible to the push service 302, the advertisement service 320, and the advertisers 108. Further, the memory area 310 or any of the data stored thereon may be associated with any server or other computer, local or remote from the push service 302 (e.g., accessible via a network).

At least a portion of the functionality of the various elements in FIG. 3 is performed by other elements in FIG. 3, or an entity (e.g., processor, web service, server, application program, computing device, etc.) not shown in FIG. 3.

Referring next to FIG. 4, an exemplary flow chart illustrates operation of the delivery of advertisements 322 to selected application programs 110. The push service 302 receives the application execution data 314. The application statistics 316 are generated at 402 based on the application execution data 314. The advertisement campaigns are accessed at 404. The application execution data 314 and the application statistics 316 affect the selection or filtering of the advertisement campaigns to support, the advertisements 322 to send, and the application programs 110 to receive the advertisements 322. In some embodiments, the application execution data 314 and/or application statistics 316 include location information for the computing devices 102. At 406, at least one of the application programs 110 is identified to receive at least one of the advertisements 322. The push service 302 delivers or otherwise provides the advertisements 322 to the targeted application programs 110 at 408 (e.g., one or more application programs).

In some embodiments, the push service 302 pushes text metadata about the advertisements 322. The application programs 110 receive notification of the text metadata and query an advertisement proxy agent (not shown) to retrieve the advertisements 322. The advertisement proxy agent serves the advertisements 322 related to the text metadata from a local cache or, if not present, pulls the advertisements 322 from the advertisement service 320. The advertisement proxy agent may pull the advertisements 322 for each of the targeted application programs 110 or for a plurality of targeted application programs 110. In such embodiments, the notification with the text metadata is small in size and the push service 302 can target a plurality of application programs 110 on the same computing device with the same advertisements 322 while conserving bandwidth and battery life.

At 410, the advertisement system calculates an amount (e.g., financial) to charge the advertiser 108 for providing the advertisement 322. The amount is calculated based on, for example, the application program 110 designated to receive the advertisement 322. For example, the amount is higher for popular application programs 110, while the amount is lower for application programs 110 that are executed less frequently. In some embodiments, the actual amount calculations are performed offline. Further, while booking the advertisement 322, the advertiser 108 may be offered pricing guidelines.

The operations illustrated in FIG. 4 may be implemented as software instructions encoded on a computer-readable medium, in hardware programmed or designed to perform the operations, or both.

In some embodiments, the operations illustrated in FIG. 4 are performed by the system 104. In other embodiments, one or more of the operations illustrated in FIG. 4 are performed by another computing device (e.g., as a web service).

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for targeting application programs 110 with advertisements 322, and exemplary means for calculating a financial amount to charge the advertiser 108 for delivering the advertisement 322.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for targeting application programs with advertisements, said system comprising:
a memory area for storing application execution data received from at least one computing device, said application execution data describing an execution environment of the computing device, said memory area being associated with a push service; and
a processor programmed to:
generate, based on the application execution data stored in the memory area, application statistics corresponding to the execution environment;
access at least one advertisement campaign defined by an advertiser;
identify, based on the generated application statistics and the accessed advertisement campaign, at least one application program on the computing device to receive an advertisement;
deliver, by the push service, the advertisement to the identified application program; and
calculate, based at least on the identified application program, an amount to charge the advertiser for delivering the advertisement.

2. The system of claim 1, wherein the processor is programmed to calculate the amount based on one or more of the following: popularity of the application program, type of the application program, frequency of application program execution, and location of application program execution.

3. The system of claim 1, wherein the processor is further programmed to:
receive location information describing a location of the computing device;
determine a location of the computing device based at least on the received location information; and
select the advertisement based on the determined location of the computing device.

4. The system of claim 1, wherein the application execution data comprises one or more of the following: application name, application type, service name, application version, and application vendor.

5. The system of claim 1, wherein the processor generates the application statistics by determining a frequency of execution of the application program.

6. The system of claim 1, wherein the processor generates the application statistics by determining a quantity of messages received by or sent from the application program.

7. The system of claim 1, further comprising means for targeting application programs with advertisements.

8. The system of claim 1, further comprising means for calculating a financial amount to charge the advertiser for delivering the advertisement.

9. A method comprising:
receiving, by a push service, application execution data from at least one computing device, said application execution data describing an execution environment of the computing device;
analyzing the received application execution data to generate application statistics corresponding to the execution environment;
accessing at least one advertisement campaign defined by an advertiser; and
identifying at least one application program on the computing device to receive an advertisement based at least on the generated application statistics and the accessed advertisement campaign, wherein the push service provides the advertisement to the identified application program.

10. The method of claim 9, further comprising selecting the advertisement campaign based on the generated application statistics.

11. The method of claim 9, further comprising selecting the advertisement based on one or more of the following: the accessed advertisement campaign and the generated statistics.

12. The method of claim 9, further comprising calculating, based on the identified application, a financial charge for providing the advertisement.

13. The method of claim 9, further comprising providing the generated statistics to an advertising system, wherein the advertising system creates a sample advertisement campaign based on the generated statistics.

14. The method of claim 9, further comprising receiving a plurality of advertisement campaigns from a plurality of advertisers.

15. The method of claim 9, further comprising:
determining a location of the computing device; and
selecting the advertisement campaign or the advertisement based on the determined location.

16. One or more computer-readable media having computer-executable components, said components comprising:
a push service component that when executed by at least one processor causes the at least one processor to receive application execution data from at least one computing device, said application execution data describing an execution environment of the computing device;
a locator component that when executed by at least one processor causes the at least one processor to determine a location of the computing device;
a business intelligence component that when executed by at least one processor causes the at least one processor to generate, based on the application execution data received by the push service component, application statistics corresponding to the execution environment; and
an ad service component that when executed by at least one processor causes the at least one processor to identify at least one application program on the computing device to receive an advertisement based on the application statistics generated by the business intelligence component, an advertisement campaign defined by an advertiser, and the location of the computing device determined by the locator component;
wherein the push service component delivers the advertisement to the application program identified by the ad service component, and wherein the ad service component calculates, based on the identified application, an amount to charge the advertiser for delivering the advertisement.

17. The computer-readable media of claim 16, wherein the business intelligence component generates the application statistics as the push service component receives the application execution data.

18. The computer-readable media of claim 16, wherein the business intelligence component generates the application statistics at a predefined time interval.

19. The computer-readable media of claim 16, wherein the business intelligence component groups application programs executing on the computing device based on one or more of the following: the user, the location of the computing device, activity of the application programs, and a popularity of the application programs.

20. The computer-readable media of claim 16, wherein the locator component determines the location of the computing device based on one or more of the following: crowd-sourced data and a global positioning system.
